(19) United States
(12) Patent Application Publication
(10) Pub. No.: US 2011/0145070 A1
(43) Pub. Date: Jun. 16, 2011

(54) SYSTEM AND METHOD FOR CREATING, DISTRIBUTING, AND MONETIZING USER-GENERATED CONTENT IN A RETAIL ENVIRONMENT

(75) Inventors: Robert I. Wolinsky, Fairfield, CT (US); Martin A. Amadio, Virginia Beach, VA (US)

(73) Assignee: Automated Media Services, Inc.

(21) Appl. No.: 12/639,691

(22) Filed: Dec. 16, 2009

(51) Int. Cl. G06Q 30/00; G09G 5/00

(52) U.S. Cl. 705/14.61; 345/2.1; 705/14.49; 705/14.69; 705/14.4

(57) ABSTRACT

A system and method for monetizing user-generated content in a retail environment may include enabling users to upload respective user-generated content via a communications network. User-generated content may be selected from one of the uploaded user-generated content submitted by one of the users. Sponsor content may be received from a sponsor for displaying in association with the selected user-generated content. A sponsored advertisement inclusive of the selected user-generated content and sponsor content may be generated and an identifier associated with the sponsored advertisement may be inserted into a playlist of content segment advertisements for display on at least one electronic display in a retail store according to the playlist. The sponsored advertisement and playlist may be distributed to the at least one electronic display for display of the sponsored advertisement on the electronic display(s) according to the playlist. Payment may be collected from the sponsor for sponsoring the sponsored advertisement.

### BACKGROUND

Today, the main distribution and viewing venue for user-generated content is the Internet. Companies, such as YouTube®, receive, store, and host user-generated content for users to view using computers or wireless communications devices via the Internet or other networks. Although the user-generated content can be quite compelling and enjoyable for viewers, which is evidenced by significant audience viewership tallies or downloads, heretofore there has been little, if any, viable system or method whereby this user-generated content has been monetized within the Internet or other networks. Typical television content programming monetizing involves the process of defraying the costs associated with the production and creation of programming by either appending advertisements or inserting product promotion messaging in the programming, which is generally known as an ad-supported television business model. Since the inception of in-home television, the ad-supported business television model provides for both free viewing of programming and the ability for advertisers to promote their products and services to a very large mass audience. Unfortunately, user generated content is not supportable by current media business models, as further described below.

The system of providing free programming to viewers for watching advertisements operates under the guise of the historically implied contract between viewer and television networks. However, in the case of YouTube®-style content viewing on the Internet, the viewer has little interest in or patience for watching advertisements, as is the nature of online or downloaded entertainment. The hosting entity (e.g., YouTube®) is not a traditional television network and, as such, has little connection to the user-generated content, which is immensely diverse, unpredictable, and largely unprofessional, which makes the process of acquiring advertisers interested in tying their products or services to the user-generated content very difficult. To illustrate the problem, one YouTube®-style hosting entity permitted the downloading of user-generated content showing three individuals in a room shouting at one another. From a business perspective, it is unclear what advertiser would desire to be associated with such user-generated content. In the traditional television-style ad-supported television model, the television networks carefully control the programming in order to attract advertisers to the audience it generates with the programming. Unfortunately, for user-generated content hosting companies, such as YouTube®, the traditional ad-supported model is difficult to replicate within the Internet content distribution model as the hosting entity exercises almost no creative control over the user-generated content, which is the essential component to the monetizing scheme of the traditional ad-supported business television model. While both systems (i.e., traditional television and user-generated content download system via the Internet) generate huge audiences for watching reality-style programming, in the case of traditional ad-supported television, even reality programming is carefully formatted to attract advertisers.

Notwithstanding the huge audiences that are attracted to user-generated content hosting websites, such as YouTube®, there is substantial evidence in the marketplace that the costs associated with hosting user-generated content, including bandwidth, computer servers, content storage facilities, content conversion systems, advertising sales staff, and the like, necessary to support the audience generating capacity of the system cannot be fully supported by place-based advertisements at the website. These hosting entities have tried to address the economic shortfall by introducing a pre-roll or other forms of interstitial advertisements before or during the user-generated content is available for viewing. Assuming Internet television viewers would be willing to watch a pre-roll of advertisements, which this assumption has proved quite unlikely, the hosting entity is faced with another daunting prospect associated with monetizing Internet television viewing, which is that the traditional process for planning and buying advertising time or space is of limited or no value in such a hosted environment.

Traditional planning and buying and media metrics depend on predictable audience delivery. Predictable audience delivery facilitates the planning and buying of a predetermined audience quantity in predictable fashion and time constraint according to the needs of advertisers. In the case of traditional television, audience delivery rates routinely reach millions of viewers per program element. No such system exists for those advertisers seeking to utilize a YouTube®-style audience delivery system. Advertisers already suffer from network fragmentation (i.e., too many television channels) and too much programming choice resulting from the 100+ channel universe now associated with cable and satellite television ad-supported networks. YouTube®-style hosting entities can be described as being hyper-fragmented, where program selection is in the tens of millions, thereby making the predictable purchase of a predetermined audience impossible. For example, while some user-generated content may attract a large audience over an extended period of time, which take be months, often using viral marketing techniques, including social networking, most user-generated content attracts a very small audience. Unfortunately, for advertisers and agencies, such user-generated content systems provide them no ability to predict audience delivery, whatsoever. Predictable, and large, audience delivery is a key metric to planning and buying of media, or the traditional monetization scheme. YouTube®-style television services are often referred to as media, therefore compelling its owners to monetize the service. However, such “media” description for such user-generated content delivery services remains a very big question as to its commercial reality. Most likely, the proper appellation or title of this YouTube®-style television is “fad media.”

Retailers are always looking for ways to draw customers to increase sales. Many retailers try to integrate themselves into a local community so that local residents come to treat the retailer as part of the community, thereby increasing sales. Retailers often allow local groups to participate in activities at the retailers, sponsor local sports teams (e.g., local baseball teams), give donations to local organizations, and hold events in which local residents may participate to promote themselves as being part of the community. Retailers often post photos of “employees of the month,” managers, and other personnel to allow local residents to become familiar with the retailer personnel, thereby letting local residents feel more “at home” with the retailer. The belief by most retailers is that the more community activities in which the retailers can participate, the more local residents will frequent the retailers. However, not all community activities draw local residents into the retailers and many retailers do not have the financial ability to participate or contribute to enough community activities as is needed to have a significant impact in establishing long-lasting relationships with the local community residents.

Moreover, competition for customers in the retail industry is very high. For example, grocery stores run sales, promotions, specials, and coupons to attract customers in for their weekly food purchases. In addition, grocery stores are always looking for creative ways to attract customers without having to lower prices.

### SUMMARY

To overcome the problems of monetizing user-generated content and attracting a larger customer base to retailers, the principles of the present invention provide for user-generated content to be controlled and creatively repurposed into an advertisement by an ad agency or similar service provider for display in a retail environment, which provides for both monetization of user-generated content and attracting a larger customer base to retailers. It has been established that retail locations provide the opportunity to supply predictable audiences for the viewing of video messages and advertisements. There are retailer organizations with customer flows, or viewers, that reach more than 100 million per week. Given the nature of predictable and large audience potential for viewing, the ideal receptivity for information of shoppers, that such locations can be utilized to effectively monetize user-generated content.

Advertisers or marketers may sponsor ads by having its content integrated with the user-generated content, thereby producing a creative ad that uses the user-generated content to draw attention to the marketer's message. Advertisers that sponsor the user-generated content advertisements for display in retail environments may benefit by the shopping “audience” paying more attention to the user-generated content and the sponsor's message. As an example of user-generated content being repurposed into an advertisement, a company, such as General Mills, may desire to promote its Wheaties® cereal brand. User-generated content that is submitted for inclusion in a sponsored advertisement may be edited by an ad agency to integrate with an image of a Wheaties® box or other marketing content for display in a retail environment or in other environments, such as in-home television or on the Internet. Advertisers also benefit by being able to purchase a large mass-audience (i.e., shoppers) in a predictable fashion, as is known in the art.

In displaying the sponsored advertisement in a retail environment, the sponsored advertisement may be distributed and displayed in one or more retail chains nationally, regionally, within designated market area(s), within one or more towns or cities, and even within a particular retail store. To adequately monetize the user-generated content, however, it is more beneficial to have wider distribution to increase audience delivery and advertising revenue and be more cost effective in terms of production costs. In one embodiment, the advertisement segment may be scheduled for display on an electronic display network within retail stores that provide for a predictable audience delivery (i.e., visitors of the retail stores), which allows the advertisers or their agencies to plan an advertising schedule, as has been historically performed on traditional in-home television networks. The ability to provide a predictable audience delivery in a form that is consistent with The Nielsen Company and other providers of such data and assessments utilized in its in-home television viewership sampling enables monetization of the user-generated content that has heretofore not been possible.

One embodiment of a system and method for monetizing user-generated content in a retail environment may include enabling users to upload respective user-generated content via a communications network. User-generated content may be selected from one of the uploaded user-generated content submitted by one or more of the users. Sponsor content may be received from a sponsor for displaying in association with the selected user-generated content. A sponsored advertisement inclusive of the selected user-generated content and sponsor content may be generated and an identifier associated with the sponsored advertisement may be inserted into a playlist of content segment advertisements for display on at least one electronic display in a retail store according to the playlist. The sponsored advertisement and playlist may be distributed to the electronic display(s) for display of the sponsored advertisement on the electronic display(s) according to the playlist. Payment may be collected from the sponsor for sponsoring the sponsored advertisement.

One embodiment of a method for monetizing an advertisement in a retail environment may include receiving, from a user, user-generated content in the form of an electronic image. A sponsored advertisement may be generated by including sponsor content and the user-generated content in an advertisement. A timeframe during which the sponsored advertisement is to be displayed may be established. The sponsored advertisement may be caused to be displayed during the timeframe on an electronic display network in a retail store, where the electronic display network may provide for a predictable and plannable audience delivery within the retail store. In causing the sponsored advertisement to be displayed, the sponsored advertisement may be scheduled for display on the electronic display network. A sponsor advertiser may be billed for the audience delivery or simply the display of the sponsored advertisement on the electronic display network.

### BRIEF DESCRIPTION OF THE DRAWINGS

Illustrative embodiments of the present invention are described in detail below with reference to the attached drawing figures, which are incorporated by reference herein and wherein:

FIGS. 1A and 1B are maps of illustrative geographical areas in which retail stores are located;

FIG. 2 is an illustration of an illustrative retail environment in which a network of electronic displays are located for shoppers to view content being displayed thereon;

FIG. 3A is an illustration of an illustrative network environment in which user-generated content may be collected and communicated to retail stores for display in the form of sponsored advertisements;

FIG. 3B is a block diagram of another illustrative network environment in which user-generated content may be distributed for display in the form of sponsored advertisements;

FIG. 4 is a screenshot of an illustrative user-generated content segment advertisement in which an advertiser is sponsoring user-generated content;

FIG. 5 is a screenshot of an illustrative user-generated content segment in which an employee of a retail store is promoting a brand product being sold by the retail store;

FIG. 6 is a screenshot of an illustrative graphical user interface that enables a customer to upload user-generated content for selection and display in a retail store;

FIG. 7 is a screenshot of an illustrative graphical user interface that enables a sponsor advertiser to submit sponsor content or an agency to select sponsor content that may be used in conjunction with user-generated content to generate a sponsored advertisement for display in a retail store;

FIG. 8 is a block diagram of an illustrative content management server that is configured to collect and manage user-generated content and sponsored advertisements for selection and distribution to retail stores for display thereat;

FIG. 9 is a block diagram of illustrative software modules that may be executed on the content management server of FIG. 8 for providing collection, management, and distribution functionality in accordance with the principles of the present invention;

FIG. 10 is a screenshot of an illustrative user-generated content selector screen for selecting user-generated content for display in one or more retail stores;

FIG. 11 is a screenshot of an illustrative ad sponsor assignor screen that enables a retail store or its agency, or an advertiser or its agency, to assign sponsor content to user-generated content for display in one or more retail stores;

FIG. 12 is a screenshot of an illustrative graphical user interface that enables users to upload user-generated content for display in one or more different chains and stores within the different retail chains;

FIG. 13 is a screenshot of an illustrative graphical user interface that enables sponsors or its agency to submit content for sponsoring user-generated content in one or more different retail chains;

FIG. 14 is a flowchart of an illustrative process for providing user-generated content submission and distribution for display in one or more retail stores as sponsored advertisements; and

FIG. 15 is a flow chart of an illustrative process for generating sponsored advertisements using user-generated content.

### DETAILED DESCRIPTION OF THE DRAWINGS

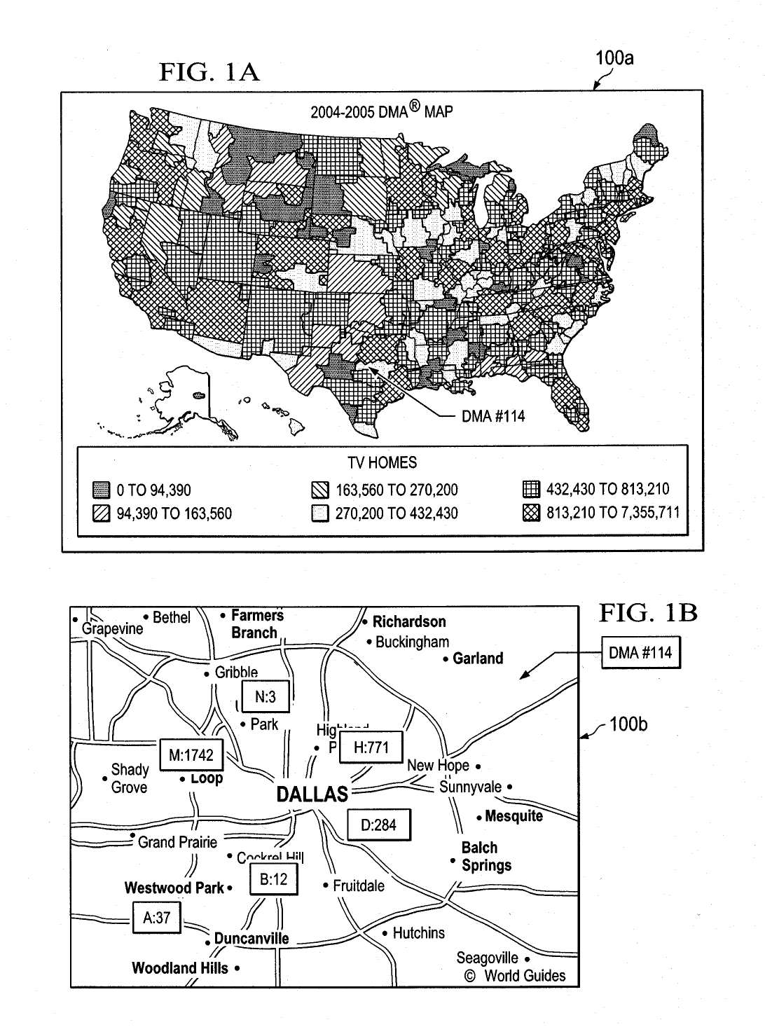

With regard to FIG. 1A, an illustration of an illustrative map 100 a of the United States showing distinct designated market areas (DMAs) is shown. There are currently 210 different DMAs in the United States. Advertisers generally desire to advertise to as many households within each DMA as possible. Traditionally, advertisers have used television to achieve their goal of advertising to as many households within each DMA as possible. However, in accordance with the principles of the present invention, advertisers may reach household members by advertising on electronic display networks within retail stores, as described in co-pending U.S. patent application Ser. No. 12/368,232 filed Feb. 9, 2009, which is incorporated herein by reference in its entirety. As shown in FIG. 1A, DMA 114 in North Texas, which includes the Dallas-Fort Worth Metroplex, may be targeted by advertisers through both traditional television broadcasting and displaying ad content on electronic display networks within retail environments. It should be understood that electronic displays and electronic display networks that are not capable of providing media metrics that provide predictable and plannable audience delivery, as provided in U.S. patent application Ser. No. 12/368,232, may not be capable of producing viable monetization of the user-generated content.

As shown in FIG. 1B, an illustrative map 100b of DMA 114 is shown. Within DMA 114, there are a number of different retail stores of retail chains that may be local affiliates of a network service provider. The local affiliates include local affiliate A, B, D, H, N, and M. Within DMA 114, local affiliate A has store number 37, local affiliate B has retail store number 12, local affiliate D has store number 284, local affiliate H has store number 771, local affiliate N has retail store 3, and local affiliate M has retail store 1742. A network service provider may operate to distribute content (e.g., video and/or photographs) via a communications network (not shown), such as a satellite communications network, mobile communications network, or the Internet, for example, to the retail stores in DMA 114. The content may include advertisements, where an advertisement may be a sponsored advertisement and include user-generated content that is sponsored by a marketer, as further described herein. The user-generated content may be selected, edited, and repurposed for use in the sponsored advertisement. By selecting and editing the user-generated content, the advertiser or its agency has creative control over the specific content with which the marketer's message will be associated, thereby incentivizing the advertiser to pay traditional advertising rates for audience delivery in a retail location and, thus, monetizing the user-generated content.

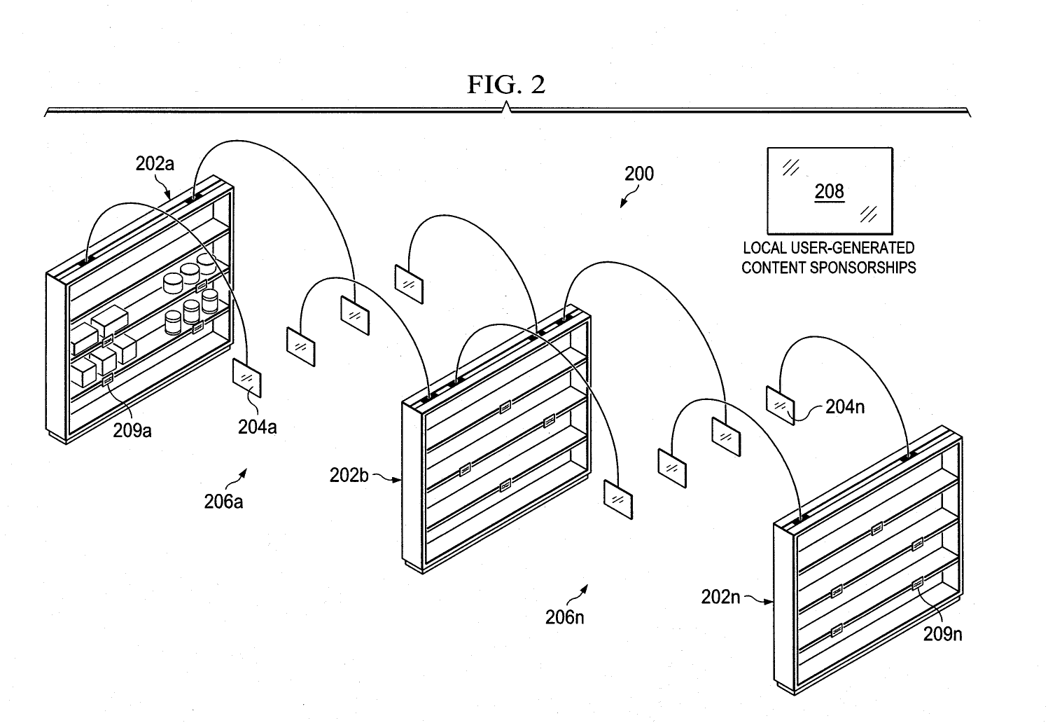

Retailers who are competing with other retailers on a local level and have an electronic display network as described in FIG. 2 may desire and even encourage the use of user-generated content by advertisers on the electronic display network. As has been demonstrated, user-generated content has the ability to attract audiences. Integrated with advertiser content to form a sponsored advertisement as described herein, the user-generated content can both attract, inform and entertain an audience (i.e., draw customers to a retailer) and generate revenue for the retailer from the advertiser who sponsors the sponsored advertisement—a win-win for the retailer and advertiser that strives to have more potential customers view its messages. Because user-generate content can be as or more entertaining than professionally produced content, advertisers may user the user-generated content to attract the attention of shoppers within the retail store. If shoppers of a retailer come to enjoy the entertaining ads while shopping, the shoppers may become more inclined to shop at the retailer than other competitor retailers. As an example, if an advertiser sponsors a local youth soccer league MVP winner in a sponsored advertisement and displays the advertisement in a particular retail chain or store, the family and friends of the MVP winner will likely visit the retail chain or store during the time period over which the sponsored advertisement is being played, which will likely increase the “good-will” for the retailer and sponsor advertiser of the family, friends, and others associated with the local youth soccer league.

With regard to FIG. 2, an illustration of an illustrative retail environment 200 is shown to include gondolas 202a-202n (collectively 202) for use in displaying products available for purchase at the retail store. The gondolas 202, in one embodiment, may further be configured to support electronic displays 204a-204n (collectively 204) that may display content, such as advertising content, for shoppers who traverse aisles or pathways 206a-206n (collectively 206) of the retail store. While shopping, the shoppers may view the content being displayed on the electronic displays 204. The electronic displays 204 may be configured as a network of electronic displays, where each of the electronic displays 204 are synchronized so that content being displayed on the electronic displays 204 is substantially simultaneously displayed (i.e., each electronic display in the network displays the same content at approximately the same time). By synchronizing the electronic displays 204, an average shopper (i.e., a shopper who shops an amount of time of an average shopping trip in that retail store) traversing the aisles 206 of the retail store may be guaranteed to have an opportunity to view each advertisement being displayed in an “ad wheel” a certain predetermined frequency. For example, each average shopper may view each advertisement three times. The number of times that an average shopper may view each advertisement being displayed on the network of electronic displays 204 may be set based on an ad wheel length, length of ads, spacing of electronic displays 204, length of time of the average shopping trip, and other variables, as described in co-pending U.S. patent application Ser. No. 12/368,232. Or, in the alternative, the displays may work independently where the content of a particular display is unique to its location in order to support goods or services available within its proximity.

User-generated content may be incorporated into an advertisement that is displayed on the network of electronic displays 204 and be sponsored by an advertiser, thereby encouraging an advertiser to spend advertising revenue proportional to, commensurate with, or more than traditional advertising as the advertiser may be guaranteed a certain audience delivery and a gross rating point (GRP) for that advertisement to be viewed. In addition, the advertiser, depending on the subject matter of the advertisement, may be viewed more favorably by a user who submits user-generated content and the user's friends and family who may visit the retail store to view the advertisement being displayed on the electronic displays 204. As has been the case with user-generated content on the Internet, customers of retailers may find the user-generated content enjoyable to watch. In one embodiment, in addition to the user-generated content being displayed on the electronic displays 204, a large-format electronic display 208 may be positioned within the retail store (e.g., on a wall or hanging from a ceiling) for exclusive or non-exclusive display of the user-generated advertisements or in connection with the electronic displays. In one embodiment, the large-format electronic display 208 may take on the form of becoming a local or “micro” news source in a similar manner as a local newspaper or news report. In other words, if user-generated content is collected from local residents, that user-generated content may be sponsored by an advertiser to form local news content. While such a format, electronic display 208, is not truly capable of providing a predictable and plannable audience delivery to truly monetize the user-generated content, the use of the large-format electronic display 208 is capable of attracting local residents to the retailer to see interesting local events in the form of user-generated content, which provides good-will for the retailer and advertiser sponsors.

The electronic displays 204, while shown to be supported by the gondolas 202, may alternatively be supported and powered by the ceiling (not shown) of the retail store. Other electronic displays, such as shelf-edge displays 209a-209n (collectively 209), may also display sponsored advertisements that include user-generated content. The shelf-edge displays 209 may be used by individual product manufacturers to promote specific brands and those manufacturers may use sponsored advertisements as promotional messages, as well.

In one embodiment, a computer station (not shown) may be available to shoppers who have user-generated content of which the shoppers want to upload for submission to be used in a sponsored advertisement. The computer station may include one or more mechanical connection mechanisms that enable the user to interface with a memory device or mobile device (e.g., mobile telephone, portable computer, etc.) to enable the user to upload the user-generated content. The connection mechanisms may be wired (e.g., Universal Serial Bus (USB)) or wireless (e.g., Bluetooth® communications protocol). The computer station may include a computer that operates a graphical user interface that enables a user to select and upload the user-generated content and allows the user to enter information associated with the user-generated content, such as date taken, name(s) of people in the user-generated content, acceptance for the user-generated content to be repurposed into an advertisement and displayed in retail store(s), approval by parents if a minor child is in the user-generated content, contact information, category in which the user-generated content is most associated, customer or customer loyalty card number, etc. The category of the user-generated content may enable an advertiser or its agency to match sponsor content that is relevant to the user generated content. It should be understood that the computer station may provide the same or similar capabilities as those made available to the customer via the retailer's website or another website available on the Internet or other communications network (e.g., mobile communications network).

In addition to the computer station, a video production station may be available for customers to become “pitch men” to create user-generated content to promote products or services of advertisers. The video production station may include a video camera that is either mounted or handheld for use in capturing the user-generated content. In addition, a “green screen” may be available to allow the user (or associate at the retail store) to dynamically select a background, as understood in the art, for creating the user-generated content. The video production station may be in communication with the computer station, or be part of the computer station, to allow for upload and submission of the user-generated content for inclusion in a sponsored advertisement.

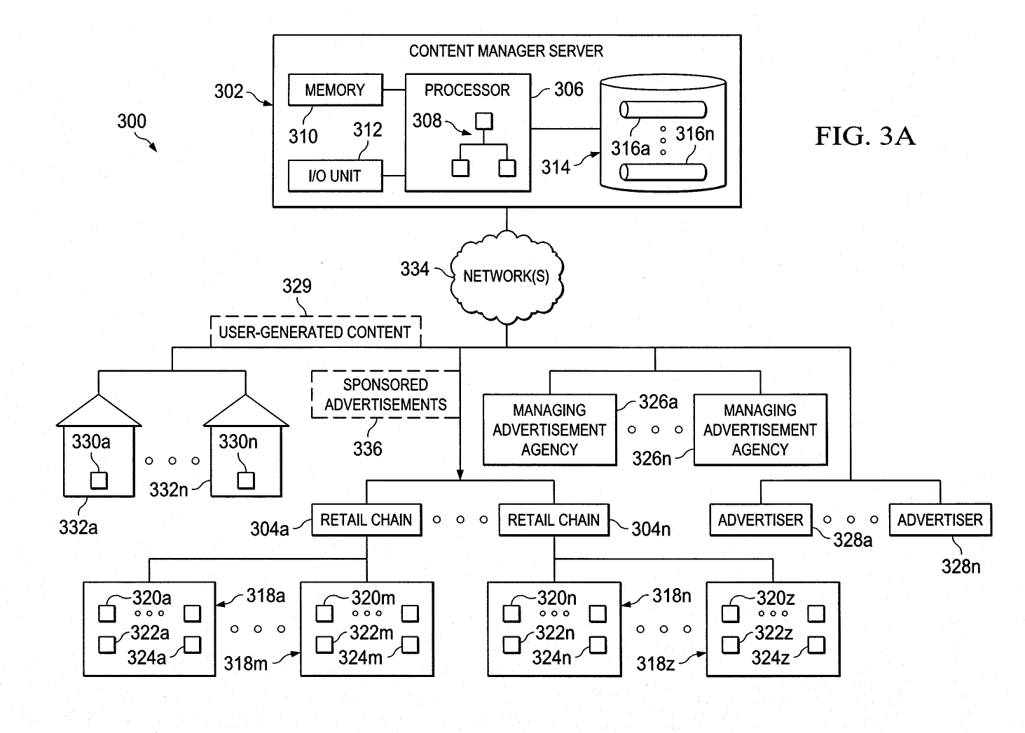

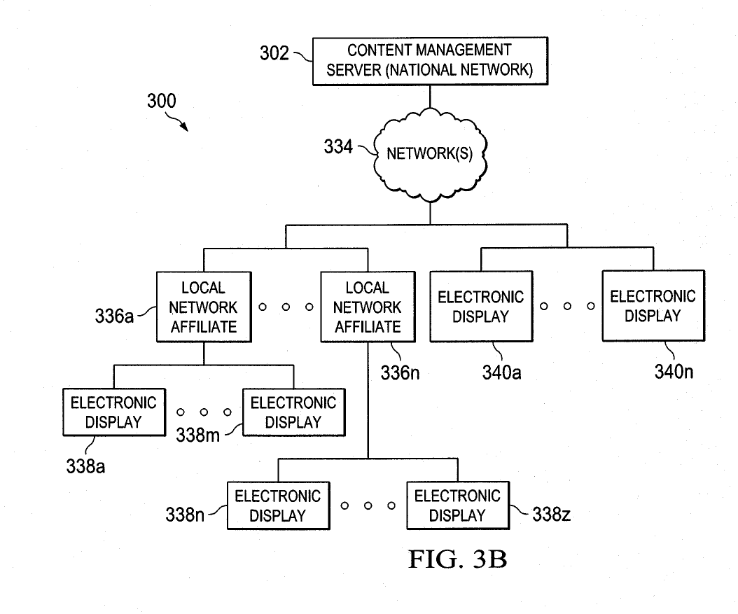

With regard to FIG. 3A, an illustration of an illustrative network environment 300 may include a content management server 302 operated and managed by a network service provider for managing and distributing content to retail chains 304a-304n (collectively 304). The content distributor server 302 may include a processing unit 306 that includes one or more computer processors that executes software 308 for managing and distributing content, including user-generated content. The processing unit 306 may be in communication with a memory 310, input/output (I/O) unit 312, and storage unit 314. The storage unit 314 may be configured to store one or more data repositories 316a-316n (collectively 316). The data repositories 316 may be configured to store content, such as advertising content, for distribution to one or more of the retail chains 304. The software 308 may be configured to manage playlists into which the content being stored in the data repositories 316 is to be included for distribution and display at particular retail chains and retail stores. If for example, one or more retail stores within a retail chain is to display user-generated content on electronic displays at select one(s) of the retail stores, then a different playlist may be established for the retail store(s) so that each of the retail stores may have a customized playlist, as opposed to a common playlist for all of the retail stores in a single retail chain. In general, however, a playlist common to (i) all retail stores within a retail chain or (ii) all retail stores within a retail chain and within in a particular DMA will be utilized to distribute the sponsored advertisements.

The retail chains 304 may each have a certain number of retail stores 318a-318m and 318n-318z (collectively 318). Within each of the retail stores 318, one or more electronic display networks 320a-320z may be arranged within the respective retail stores to enable shoppers to view each of the electronic displays as the shoppers move throughout the retail store. Each of the retail stores 318 may also include a local server 322a-322z that operate to receive content and playlists from the content distributor server 322 for communicating the content to respective electronic display networks 320. In addition, a content submission kiosk 324a-324z may be located in each of the respective retail stores 318 to allow customers to upload user-generated content. It should be understood that communications of the content may be direct to the electronic displays via a communications network without passing through a local server at a retail store. It should also be understood that content submission may be from a computer or other device not located in the retail store and not passing through the submission kiosk.

Each of the retail chains 304 may have the same or different managing ad agencies 326a-326n (collectively 326) that operate to manage (e.g., coordinate, create, edit content, sell, etc.) airtime and handle advertising to be displayed on the respective electronic display networks 320. The managing ad agencies 326 may be contracted by respective retail chains 304 to manage airtime on each of the electronic display networks 320, where, in one embodiment, a national network manager or network service provider that operates the content manager server 302 may be allocated “national airtime” and each of the retail chain 304 or local affiliates may be allocated “local airtime.” The national airtime may be 60 percent of the airtime (e.g., 36 minutes per hour) that is available on the electronic display networks 320 across each of the retail chains 304 and the local airtime may be 40 percent (e.g., 24 minutes per hour) of the airtime available on the electronic display networks 320 in each of the respective retail chains 304. Each of the national network manager and retail chains or their managing ad agencies 326 may sell or otherwise commercialize the airtime partitioned or allocated thereto. The airtime may be segmented into time slots or “avails” that can be used to display advertisements, where the national airtime is segmented into national avails and the local airtime is segmented into local avails. The national network manager or its agency can then sell national avails across multiple local affiliates and the retail chains or their managing ad agencies 326 can sell local avails across multiple retail stores within respective retail chains.

The managing ad agencies 326 or any other agency may find traditional advertisers 328a-328n (collectively 328) for advertising on the electronic display networks 320. The managing ad agencies 326 may seek to fill up the local airtime for clients, the retail chains 304, thereby allowing the retail chains 304 to generate revenue for local airtime apportioned thereto. Although the managing ad agencies 326 may operate to manage airtime, the managing ad agencies 326 may also operate to provide creative services to produce the sponsored advertisements for either or both of the retail chains 304 and advertisers 328. It should be understood that the advertisers 328 and retail chains 304 may use ad agencies other than the managing ad agencies 326 to generate the sponsored advertisements using the user-generated content. However, given that the advertisers or their agencies will typically generate the sponsor content, the managing ad agencies 326 may integrate the user-generated content and sponsor content without much difficulty to produce a sponsored advertisement. Alternatively, the marketer's agency may integrate the user-generated content into a sponsored advertisement. Still yet, other agencies, content providers, and/or content collectors (e.g., YouTube®).

Because the electronic display networks 320 may be configured to provide for backwardly compatible traditional media metrics that are analogous to those on traditional television, the managing ad agencies 326 may find advertisers 328 that are willing to pay for the airtime without requiring the advertisers 328 and their ad agencies (not shown) to change their paradigm from television advertising. In other words, the electronic display networks 320 may be considered out-of-home television with the audience being shoppers rather than home viewers. However, unlike home viewers of television, the shoppers are unable to fast-forward, record, or switch channels and, therefore, may be considered a better audience than home viewers of in-home television. Furthermore, the advertisements that are displayed on the electronic display networks 320 may be of products located in the retail stores 318 and therefore drive sales immediately, which effectiveness may be measured at the cash registers, as opposed to advertisements displayed on traditional television, which may be difficult to determine effectiveness of motivating someone to purchase the product being advertised as the product is not “within reach” of the viewer at that time. Given that traditional television has become fragmented, advertisers may consider that retail stores, especially grocery stores, drug stores, mass merchants represent the last mass audience to which advertisements can be targeted.

To provide users with the ability to more conveniently upload user-generated content (UGC) 329, users may utilize computers 330a-330n (collectively 330) within each of their respective homes 332a-332n (collectively 332). Users may upload the user-generated content 329 via network(s) 334 to the content management server 302 or other content management servers (not shown) with the same or analogous functionality as content management server 302 operated by the retail chains 304 or managing ad agencies 326. The users may utilize the computers 330 to access a webpage, for example, to upload the user-generated content 329, whereby the user-generated content 329 may be utilized for creating advertisements 336 sponsored by the advertisers 328. The sponsored advertisements 336 containing the user-generated content may be communicated along with a playlist (not shown) to specific retail stores 318 of the different retail chains 304 via the network(s) 334 for display on the respective electronic display networks 320. It should also be understood that non-user generated content may be communicated to the retail chains 304 for display on the electronic display network 320. The network(s) 334 may include one or more of the Internet, satellite communications network, mobile telephone network, or otherwise. By providing the users or customers with the ability to upload user-generated content 329 at the retail stores via computer stations or at home using computers 330, the users are more easily able to upload user-generated content, thereby providing for higher submission rates of user-generated content 329 to produce more sponsored advertisements 336, which may result in more loyal customers of each of the retail chains 304.

With regard to FIG. 3B, in addition to the network environment 300 including the network elements as shown in FIG. 3A, the content management server 302, which may operate as a national network manager server, may also manage and distribute content to local network affiliates 336a-336n (collectively 336) of the national network service provider. Local network affiliates 336a-336n (collectively 336) may be those of a traditional television network located in different cities and states throughout the country or be different retail chains, as provided in FIG. 3A. The local network affiliates 336 may each distribute content to electronic displays 338a-338m and 338n-338z, respectively, where the electronic displays 338 may be televisions located at homes of consumers. Alternatively, the electronic displays may be a network of electronic displays, such as the electronic display network 320 as shown in FIG. 3A. In addition, electronic displays 340a-340n (collectively 340) may be televisions, computers, wireless devices, or any other electronic displays that consumers may access user-generated content available from the content management server 302 via the network(s) 334. The electronic displays 340 may provide for user interaction via websites or simply receive content being pushed by the content management server 302 or an associated server (not shown). In summary, the content management server 302 may operate in the retail space, as provided in FIG. 3A, or traditional media or web media, as understood in the art. The user-generated content may be included in sponsored advertisements by advertisers, where the advertisers' names and/or logos may be associated with the user-generated content in the advertisements. The sponsored advertisements may be monetized more effectively in plannable and predictable media spaces, such as retail or traditional television, than the Internet space for at least the reasons previously described.

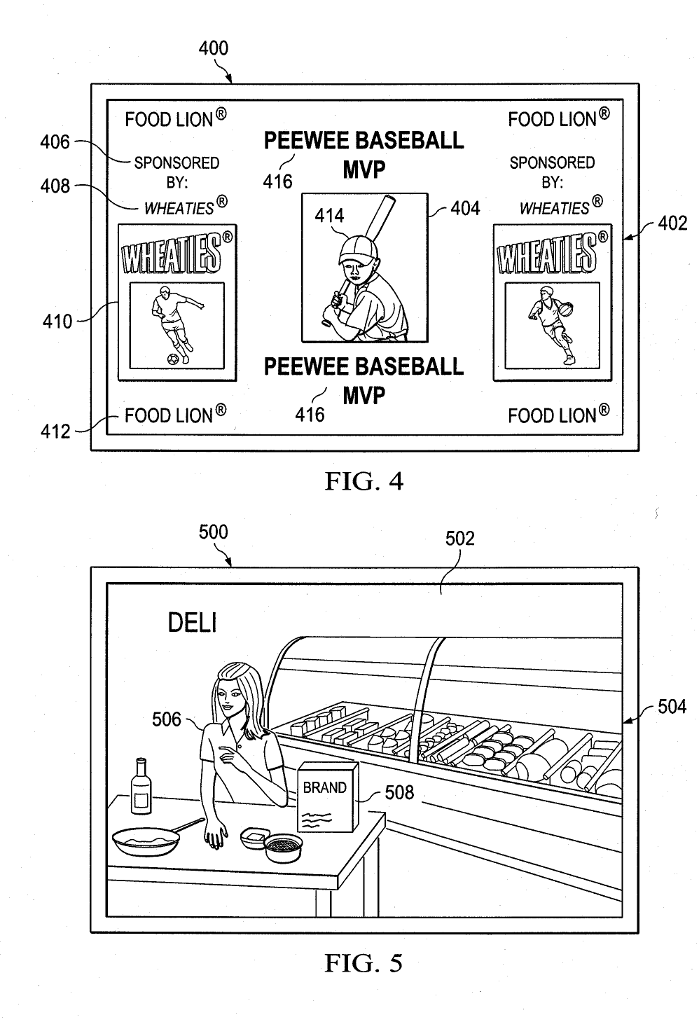

With regard to FIG. 4, an electronic display 400 including a screen 402 may be configured to display content, such as advertising content, in the form of images (e.g., photographs, graphics, and videos). In one embodiment, the content may include user-generated content 404 that is part of an advertisement sponsored by an advertiser. In one embodiment, the advertisement, which is a user-generated content advertisement segment that is a video of a certain length (e.g., six seconds) includes a sponsor section 406 that lists the name of the sponsor 408 and/or indicia or logo 410 of the sponsor. As shown, the sponsor is “Wheaties®”, a brand of General Mills, Inc., and the logo 410 is an image of a Wheaties® cereal box. In addition to showing the name and/or logo of the sponsor, the retailer (e.g., Food Lion® grocery stores) may show a name and/or logo 412 to remind or reinforce the customers viewing the user-generated content advertisement segment of the retail store brand. It should be understood that the user-generated content 404 may be a photograph or a video and the sponsor content may be graphics, photographs, video, or otherwise.

Although shown as a frame or border surrounding the user-generated content 404, the sponsor content may have be positioned in any other format, such as split-screen, title, intermixed (e.g., share airtime by displaying the user-generated content 404 for the first three seconds and the sponsor content for the last three seconds, for example). In addition or alternatively, the sponsor content may include audio. The user-generated content 404 is shown to be that of a Peewee baseball MVP 414, as indicated by a story line 416. In this case, the sponsor, Wheaties® cereal brand, has elected to sponsor youth sports. It should be understood that any other category of user-generated content may be available for users to submit user-generated content for advertisers to sponsor. The other categories may include, but not be limited to, academics, marriages, births, politics, or any other category that advertisers may be willing to sponsor and pay rates that are commensurate or proportionate with other forms of advertisements on the retail electronic display network or other communications networks (e.g., traditional television).

With regard to FIG. 5, an electronic display 500 is showing user-generated content 502 on screen 504. The user-generated content 502, in this case, includes the image of an employee 506 who is working in a deli section of the retail store and promoting a brand product 508 that is available for purchase. By having the employee 506 promote the brand product 508, the advertiser is receiving local brand endorsement and the retailer is promoting their employees, who become “pitch men” and may become “celebrities” to the shoppers of the retail store, thereby improving the “community image” of the retailer. In the case of promoting a brand by the retail store employee 506, the advertiser, who is the manufacturer of the brand product 508, need not have an advertiser name or logo displayed in conjunction with the advertisement so as to make the user-generated content appear more natural and less of a promotional advertisement. Of course, other sponsored advertisement embodiments may display the advertiser's name and/or logo. While an employee promotion is not per se user-generated content, customer “pitch men” ads may be created in the same or similar manner and may be considered more traditional user-generated content. However, for the purposes of this description, employee promotional “pitch men” content is considered user-generated content.

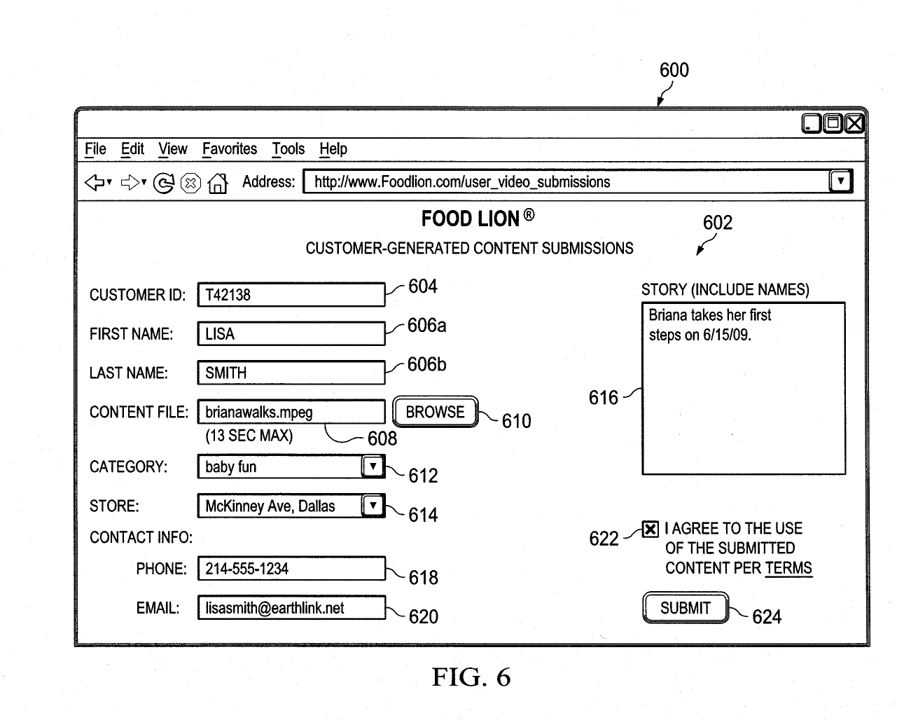

With regard to FIG. 6, a browser 600 being executed on a computer or wireless communications device (e.g., mobile telephone) may display a graphical user interface 602 that enables a user to submit user-generated content to a retailer or its agency or marketer or its agency for selection and display in a sponsored advertisement. The GUI 602 may display a number of data fields that a user may enter information or the information may be auto-populated depending upon data entered in one or more of the data fields. For example, the user may enter a customer ID into data field 604, where the customer ID is a number or alphanumeric text that may be associated with a customer loyalty card. The user may enter his or her name in the first name data field 606a and last name data field 606b. Alternatively, based on the customer ID entered in the data field 604, the first 606a, last name data fields 606b, phone field 618, and email field 620, respectively, may be auto-populated with the customer's first name, last name, phone number, and email address. The user may enter a content file name in data field 608, where the content file may be a photo data file or video data file. If the user does not know the specific name and location of the content file, then the user may select a “browse” soft-button 610 that enables the user to search through his or her computer directory to locate the content file, as understood in the art.

In addition to the user entering the content file for upload to a server located on a communications network, the user may enter or select from a list of potential categories a category in which the content file is most associated. For example, the categories may include a list of potential categories that advertisers have or may be willing to sponsor, such as sports, academics, art, foods, music, and so on. The categories may be any number of categories and sub-categories (e.g., sports/baseball, sports/cheerleading, academics/math, academics/spelling bee, foods/cooking, etc.). Any newsworthy or entertaining event or happening may result in a category or subcategory. Different stores in different geographic areas may have different categories and subcategories (e.g., scuba diving in Florida and snowmobiling in Michigan). The user may select the category using a drop-down menu, as understood in the art, or any other graphical user interface element. The user may additionally select a store in data field 614 from among a plurality of stores in a retail chain, such as Food Lion® grocery stores, to allow the user to notify viewers which retail store is the shopper's primary retail store. Alternatively, rather than entering a particular store, a “town” or other geographic location designator (e.g., state) may be used to provide more anonymity. The user may also be requested to submit a story in data field 616 that provides reviewers with information that can help the reviewers understand the relevance of the user-generated content with respect to its newsworthiness or entertainment value. The story submitted should include names and dates to allow the ad agencies or retailer to post the information if the user-generated content is selected for sponsorship by an advertiser.

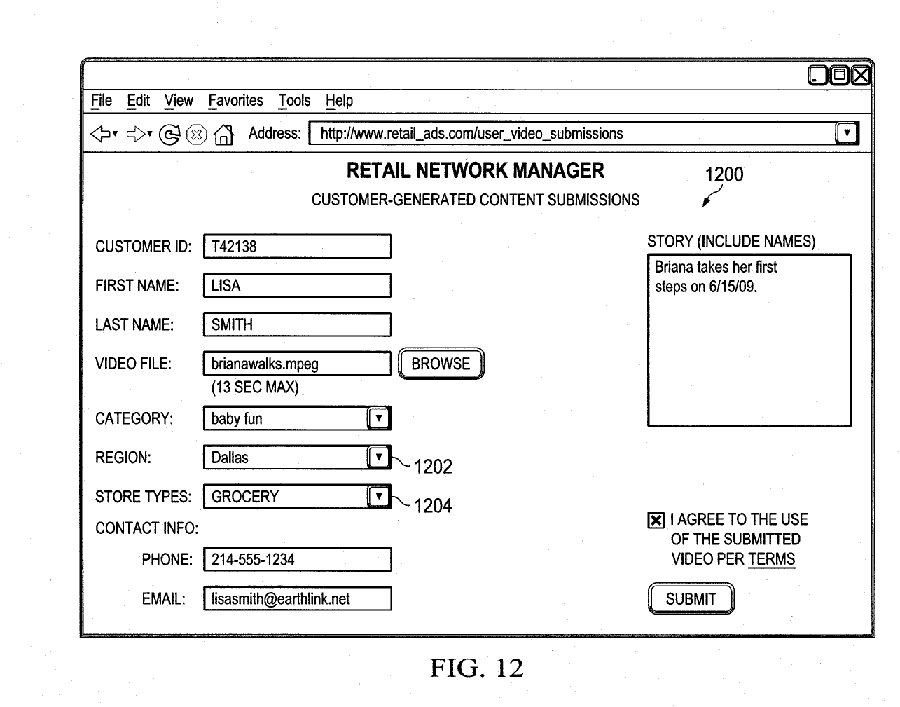

So that the user and retail chain mutually gain benefit from the selection of the user-generated content, contact information in the form of a telephone number and/or e-mail address may be entered into data fields 618 and 620, respectively, so that the retail store or its ad agency or marketer or its agency may notify the user of selection of the user-generated content, thereby allowing the user and his or her family and friends to visit a retail chain store during the dates that the user-generated content is to be displayed. Alternative contact information may also be able to be submitted, including instant message address or any other electronic or physical address. Contact information of other people, such as family and friends, to which the user desires to notify of selection and display of the user-generated content in the form of a sponsored or non-sponsored (e.g., user-generated content without have a sponsor advertiser) advertisement may also be submitted using data fields (not shown), thereby enabling the system to automatically notify the other people of display location and dates/times. Once the user has entered the requested information and identified the user-generated content, the user may select a soft-button or other GUI element 622 to indicate that he or she has read and agreed to terms for uploading and displaying the user-generated content per terms of the retailer. Once the GUI element 622 is selected, the user may select a “submit” soft-button 624 for uploading the user-generated content and associated information that the user has entered. While FIG. 6 is meant to provide a retail chain or its managing advertising agency the ability to collect user-generated content for creating sponsored ads for local avails on a chain-wide, regional, or local basis, FIG. 12 provides for user-generated content submissions to create sponsored ads for display in national avails on a national, regional, or DMA basis for display in more than one retail chain. In addition to users submitting user-generated content, the principles of the present invention provide for advertisers or their agencies to “troll” for user-generated content in specific categories, such as tomato sauce, cheese, coffee, noodles, pasta, hardware, etc.

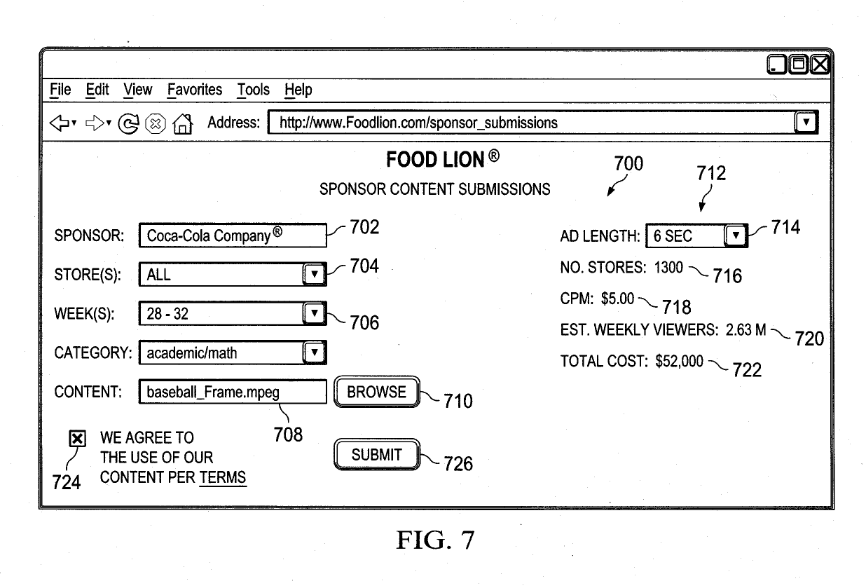

With regard to FIG. 7, a screenshot of an illustrative GUI 700 that enables a sponsor to submit content for creating a user-generated content advertisement segment is shown. Alternatively, a fully assembled content that includes user-generated content and the sponsor content in a ready-to-be-viewed fashion may be submitted via the GUI 700 or a slightly different version that enables the advertiser to submit a completed sponsored advertisement. The GUI 700 may include a sponsor entry data field 702 that enables the sponsor to type in or otherwise select a sponsor name. The sponsor may also enter or select one or more stores, regions, DMAs, retailers, etc., in which the sponsor desires to sponsor user-generated content in data field 704. A sponsor may also select one or more weeks in data field 706. Other sponsor time periods may be available, such as months, times of day, etc. The sponsor may also select a specific category to sponsor using data field 708. To upload content for the retailer or its agency to use, the sponsor or advertiser may enter the name and computer storage pathname of the sponsor content. Alternatively, the sponsor may select a “browse” soft-button 710 that enables the sponsor to search through a computer directory system to locate and select the sponsor content, as understood in the art.

The GUI 700 may also include a sponsor computation section 712 that enables the sponsor to enter an ad length in a data field 714 that a sponsor or its advertising agency desires to run a sponsored advertisement (e.g., six seconds). The ad length selections may be multiples of a minimum ad length (e.g., 6 seconds, 12 seconds, 18 seconds) available to be displayed on an electronic display network operated within a retail store. Once the ad length is selected, a number of ad cost parameters may be displayed, including number of stores in data field 716, cost per thousand (CPM) or cost per point pricing in data field 718, estimated weekly viewers or audience delivery in data field 720, and total cost, based on estimated audience delivery, for the sponsored user-generated content advertisements in data field 722. In an alternative embodiment, rather than showing estimated weekly viewers or audience delivery, estimated gross rating points (GRPs) based on the selected store(s) may be presented. The various ad cost parameters may be stored in a data repository, such as a database, and be used for calculating cost for advertisers. If the sponsor agrees with terms and conditions of the retailer, its ad agency, and/or the network service provider, then the sponsor may select a graphical user element 724 that indicates that the sponsor has agreed and select a “submit” soft-button 726 for submitting the advertisement purchase request. The sponsor content may thereafter be included with a user-generated content advertisement segment, which may be created by an agency of the retailer. It should be understood that the sponsor may send the ad agency content through other means as opposed to submitting the sponsor content through the GUI 700, but still request the purchase of advertisements through the GUI 700.

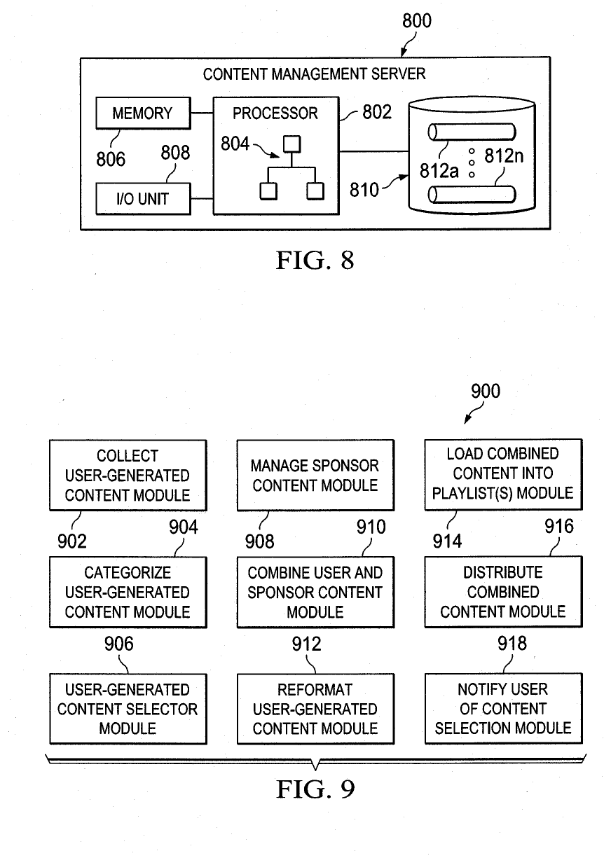

With regard to FIG. 8, a block diagram of an illustrative content management server 800 that is used to collect, manage, and distribute user-generated content is shown. The content management server 800 may include a processing unit 802 that may be configured of one or more processors that execute software 804. The software may be configured to collect, manage, and distribute the user-generated content. Management of the user-generated content may include generating a user-generated content advertisement segment by combining the user-generated content with sponsor content. The processing unit 802 may be in communication with a memory 806 that is configured to store data and software, I/O unit 808 that is configured to communicate data over a communications network using any communications protocol, as understood in the art, and a storage unit 810 that is configured to store one or more data repositories 812a-812n (collectively 812). The data repositories may be configured to store user-generated content that is uploaded by a user to the content management server 800 and sponsor content that is provided by a sponsor for use in generating user-generated content advertisement segments that are used for advertisements by the sponsors.

The content management server 800 may be utilized by a managing ad agency that represents a retail chain, the retail chain itself, or a network manager, where the network manager may use the content management server 800 for distributing content to retail stores of one or more retail chains. If a managing ad agency is using the content management server 800, then the managing ad agency may represent one or more retail chains and the software 804 may be configured to enable the ad agency to distinguish user-generated content that is being uploaded from customers of different retail chains and associate the user-generated content with the specific retail chain that the user-generated content is being uploaded for selection and display. In one embodiment, the content management server 800 may be utilized to collect user-generated content from customers or non-customers of one or more different retail chains, generate sponsored advertisements, and communicate the sponsored advertisements to another content management server, such as content manager server 302 (FIG. 3), for inclusion in a playlist and distribution to the appropriate retail store(s).

With regard to FIG. 9, modules 900 that may be part of the software 804 (FIG. 8) are shown to include a number of different functions, including collection, categorization, processing, management, and distribution of user-generated content. The modules may include a collect user-generated content module 902 that enables a user to upload user-generated content from a website via the Internet, in-store kiosk, wireless communications device, or any other uploading technique, as understood in the art. The collect user-generated content module 902 may be configured to collect not only the user-generated content, but other information associated with the user and subject of the user-generated content. For example, the user-generated content module 902 may be configured to create a graphical user interface, such as that showing in FIG. 6, to collect customer ID, name, category of the user-generated content, store, contact information, story, and so on.

A categorized user-generated content module 904 may be configured to categorize the user-generated content into one of multiple different categories for which advertisers are willing to sponsor the user-generated content. The categorized user-generated content module 904 may be configured to sort and manage the user-generated content in a data repository according to the user-generated content category submitted by a user or defined by an operator or reviewer at a retailer or ad agency. The categorized user-generated content module 904 may provide both categories and sub-categories that allow users submitting the user-generated content via the collect user-generated content module 902 to select when submitting the user-generated content.

A user-generated content selector module 906 may be configured to enable reviewers of the user-generated content to select which user-generated content is to “win” selection for an advertiser to sponsor. The user-generated content selector module 906 may operate in a number of different ways, including providing an election or poll from each reviewer, providing a grading system that allows each reviewer to give a grade to each content using one or more categories (e.g., lighting, humor, color, smiles, cuteness, or any other category that may be deemed to be good quality and content for an advertiser to sponsor). The user-generated content selector module 906 may collect votes or grades from the different reviewers and apply an indicia to a data record associated with the user-generated content to indicate that the reviewers selected that user-generated content. The user-generated content selector module 906 may also be configured to generate a graphical user interface that allows each reviewer to watch each content within a category and store to be viewed and applied a grade or selection by the reviewer. The user-generated content selector module 906 may enable the reviewers to select category and store in the review process. In one embodiment, the user-generated content selector module 906 may allow for users, such as customers, to review the user-generated content and vote, thereby enabling customers to be further engaged in the process and be attracted to a retail chain's website.

A manage sponsor content module 908 may be configured to collect and manage sponsor content for use in generating user-generated content advertisement segments for use in advertising for the advertisers. The manage sponsor content module 908 may be configured to allow an advertiser to specify particular categories for which the sponsor content is to be applied. For example, and as shown in FIG. 4, the sponsor content may be a graphic that includes name and/or logo of the sponsor advertiser or may include a photograph or video that may be used to create an advertisement in conjunction with the selected user-generated content.

A combined user and sponsor content module 910 may be configured to combine the selected user-generated content with the sponsor content. The combined user and sponsor content module 910 may be a separate module that operates within the software 804 (FIG. 8) or may be a separate software program that operates on the content management server 800 (FIG. 8) or a separate computing system that may be in communication with the content management server 800. The module 910 may be configured to provide a user with video and image editing capabilities and have the ability to combine multiple tracks or layers of images, including photographs, graphics, and video (e.g., sponsor content and user-generated content) and generate text or graphics for inclusion in a sponsored advertisement.

A reformat user-generated content module 912 may be configured to reformat user-generated content from a format in which the user-generated content is uploaded to a format that is common to all user-generated content for use in creating or distributing the user-generated content advertisement segment. The reformat user-generated content module 912 may be configured to convert the format from a high resolution format to a lower resolution format that requires less memory for storing the user-generated content and bandwidth for communicating the user-generated content in a sponsored advertisement via a communications network to an electronic display at a retail store for display thereat. The reformat user-generated content module 912 may be configured to operate in the same or analogous manner as that conventionally used on the Internet, such as performed by YouTube® reformatting of user-generated content. The reformat user-generated content module 912 may be executed as part of the software 804 (FIG. 8) or operate as a separate software program on the same or different server.

A load combined content into playlist(s) module 914 may be configured to load the combined or sponsored content (i.e., user-generated content and sponsor content) that is in the form of a user-generated content advertisement segment having a certain length (e.g., six seconds) into a playlist by assigning an identifier, such as a file name, into the playlist that is to be distributed to one or more retail stores in a retail chain for distribution to electronic displays in an electronic display network. The playlist may include user-generated content advertisement segments and non-user-generated content advertisement segments that are to be distributed to retail stores for display on an electronic display (e.g., electronic display 208 or 209a (FIG. 2)) or on a network of electronic displays (e.g., electronic display network 204).

TABLE I shows an illustrative playlist including sponsored advertisements. As shown, there are two different ad types, traditional and sponsored. The traditional advertisements are those that are produced by professional advertising agencies or the like. Sponsored advertisements, by contrast, may be produced by using user-generated content, such as that produced by a user using his or her own video camera or using a video production station, as described with regard to FIG. 2. Sponsored advertisements may also be produced by creating user-generated content of an employee at a grocery store endorsing a product, such as lamb chops, and encouraging shoppers to visit the meat section of the store to purchase lamb chops. A sponsor advertiser, such as the producer of the lamb chops, may pay for the employee endorsement, user-generated sponsored advertisement. TABLE I shows a retailer in which the ads are to be played. In addition, TABLE I may also include specific stores (e.g., store IDs) (not listed) in which the sponsored ads may be displayed due to the user-generated content being relevant to those stores (e.g., soccer MPV winner in a specific town). In one embodiment, the cost for an endorsement, sponsored advertisement may cost the sponsor advertiser more than that of a user-generated content, as the retailer would likely charge for its endorsement and for use of employee time. It should be understood that TABLE I is illustrative and that ad type and retailer parameters may not be included in an actual playlist.

TABLE I
Playlist with User-Generated Content

| Ad ID | Ad Type | Start Date | Stop Date | Retailer |
|---|---|---|---|---|
| Coke124.mpeg | Traditional | Oct. 1, 2009 | Oct. 7, 2009 | Food Lion |
| Wheaties-peewee.mpeg | Sponsored | Oct. 1, 2009 | Oct. 7, 2009 | Food Lion |
| Cheerios742.mpeg | Traditional | Oct. 1, 2009 | Oct. 7, 2009 | Food Lion |
| Lambchopsale.mpeg | Sponsored | Oct. 1, 2009 | Oct. 7, 2009 | Food Lion |
| . . . | . . . | . . . | . . . | . . . |

A distribute combined content module 916 may be configured to distribute the advertisements, including user-generated content advertisement segments (i.e., sponsored ads), that are contained in a playlist to retail stores of retail chains. If individual retail stores have user-generated content advertisement segments that are different from other retail stores (e.g., different ads on a DMA by DMA basis), the retail stores may have different playlists associated therewith and have the different content distributed to each of the respective retail stores along with reflective playlists.

A notify user of content selection module 918 may be configured to notify a user who submitted user-generated content that his or her user-generated content was selected for an advertisement. The module 918 may be configured to use an electronic address or physical address for communicating a message to the user of the selection of the user-generated content, the anticipated dates of play in the particular retail store or stores, and sponsor of the user-generated content advertisement. The message sent by the module 918 may be in the form of a text message, e-mail, instant message, posting on a website, or physical letter mailed to a physical address.

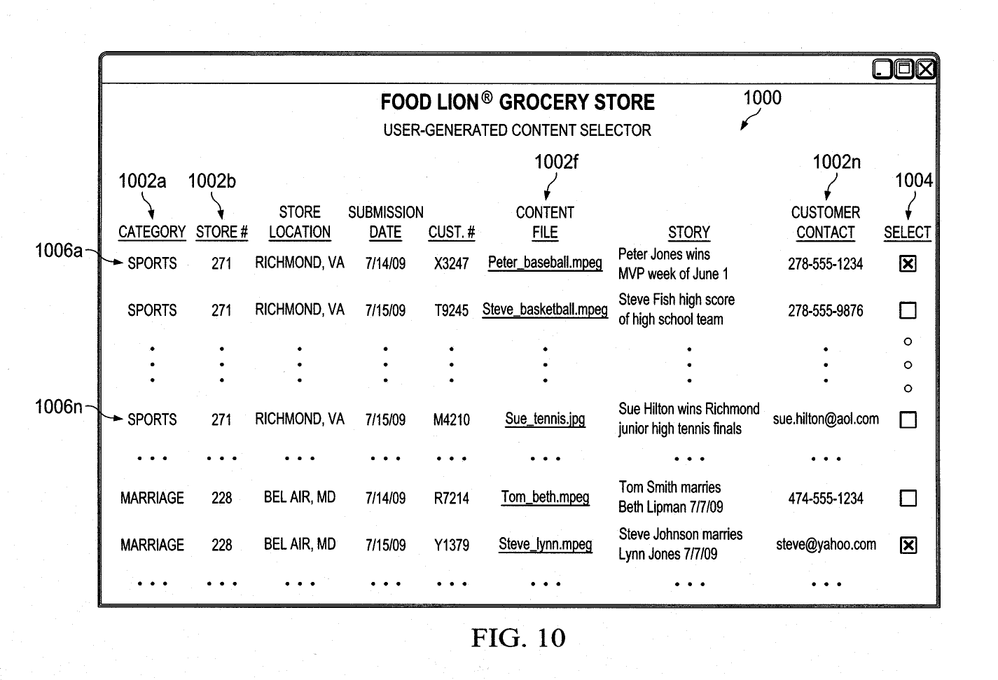

With regard to FIG. 10, a screenshot of an illustrative GUI 1000 is shown to enable selection of user-generated content for use in a sponsored advertisement. The GUI 1000 may be configured as a spreadsheet or table that has a number of different columns 1002a-1002n that identify category, store number, store location, submission date, customer number, content file, story of the user-generated content, and customer contact information. It should be understood that other information, such as customer address, number of previous submissions, and event date, may be listed as well. A select column 1004 may enable a reviewer of the user-generated content to select which content to be used for a sponsored advertisement. In reviewing the user-generated content, a reviewer may select a link identified by content file names listed in a content file column 1002f or other indicia. As shown, a number of different categories in a category column 1002a that indicates categories of associated user-identified content may be listed. The listing in the GUI 1000 may be organized, sorted, or sortable by category and store number so that the reviewer is able to compare user-generated content that is submitted for a particular category and a particular store more easily. It should be understood that rather than listing by store, a listing by geographic area (e.g., town name) may be available and utilized. For example, under a sports category, data records 1006a-1006n may each be directed to sports that have occurred within the Richmond, Va. area surrounding a particular store number (e.g., store number 271). The reviewers may select the user-generated content in the sports category that is determined to have the highest quality, best content, cutest child, most important, most relevant, most timely, or any other factor. Although not shown, in making a selection, rather than the user simply selecting a select checkbox in column 1004, the reviewers may grade each content as previously described and the selection may be automatic by software that calculates average grades for each of the user-generated content by each of the reviewers. The reviewers may be agency employees, store employees, and/or customers or non-customers of the retail store chain.

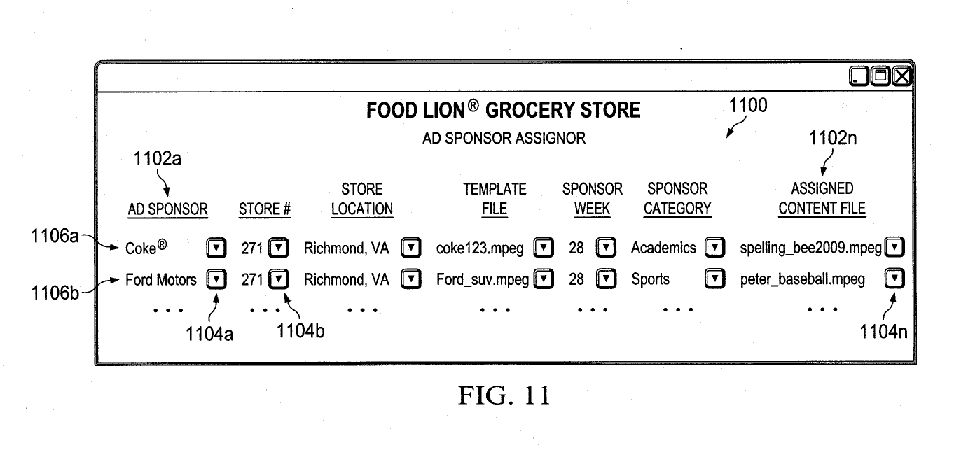

With regard to FIG. 11, a GUI 1100 is shown to include a number of different columns 1102a-1102n that may be used to manage and assign sponsor content to the user-generated content. As shown, an ad sponsor may be selected by a pull-down menu 1104a to select an ad sponsor who desires to sponsor an advertisement that includes user-generated content. The ad sponsor may be assigned a store number or itself select a store number that is within a specific store location. Alternatively, rather than being selected on a store basis, a geographic basis (e.g., DMA) or retail chain may be utilized. A template file that includes sponsor content submitted by the ad sponsor may be selected and sponsor week may be selected for sponsoring the user-generated content. The sponsor may also select a sponsor category (e.g., academics) and sponsor sub-category (e.g., academics/spelling bee). An assignor may assign a user-generated content file that has been submitted and that has won or been selected to be displayed in a sponsored advertisement. The assignor may be an employee of the retail chain, managing ad agency, sponsor advertiser, ad agency of a sponsor advertiser, or combination thereof. Data records 1106a and 1106b show two different sponsored advertisements that have been assigned an ad sponsor with user-generated content. The number of sponsored advertisements may vary from (i) DMA to DMA within one or more retail chains and (ii) retail chain to retail chain on any given week based on the number of sponsor advertisers that are willing to sponsor advertisements, the number of user-generated content submissions for any particular category, and so on.

With regard to FIG. 12, an illustrative GUI 1200 is shown for enabling a retail network manager or its agency to manage user-generated content submissions across multiple retail chains. In other words, if a user who submits the user-generated content wants selection consideration in one or multiple different retail chains, then the user submitting the user-generated content may use the GUI 1200 rather than having to upload the user-generated content with multiple retail chains. The GUI 1200 may be provided or made available by a network manager, ad agency, or other organization that provides the ability for user-generated content to be submitted across multiple retail chains as opposed to the GUI 602 (FIG. 6) that was limited to a single retail chain, in this case, Food Lion®. As shown, a user may select a retail chain from among retail chains that are available by selecting using a pull-down menu selector 1202 that may show multiple regions (e.g., state, city, town, zip code) from which a user may select.

Once a retail chain is selected, the user may use a pull-down menu selector 1204 for selecting a particular retail chain (e.g., Food Lion grocery store) or store type (e.g., grocery) within the selected region. The retail store may be organized alphabetically or by geographic location. Multiple retail chain and store data fields with pull-down menu selectors may be available for simplicity. As an alternative, rather than using a pull-down menu selector as shown, other types of graphical user interface selection mechanisms may be used for the user to select one or more retail chains and one or more stores within each of the retail chains for the user-generated content to be submitted. In one embodiment, the number of submissions that a user may submit may be free or a charge may be associated with submitting in different numbers of retail chains and stores within the retail chains, in locations outside of the user's primary residence, or otherwise. By enabling a user to submit user-generated content to different retail chains and stores within the retail chains, a user or shopper may attempt to have his or her user-generated content accepted by different stores, which ultimately results in a benefit for the different retail stores or chains by delivering more customer traffic to those retail chains through word of mouth by the user to his or her family and friends.

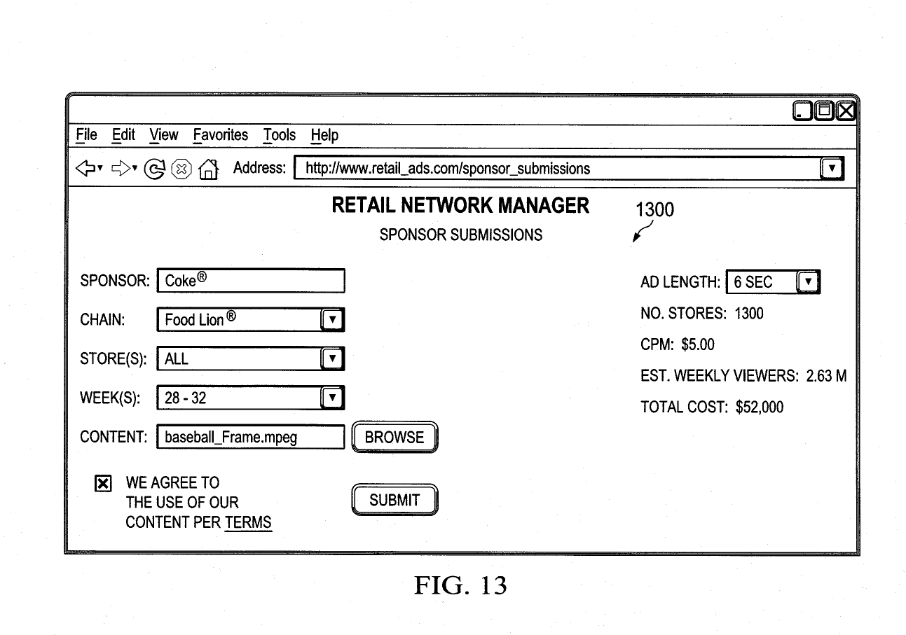

With regard to FIG. 13, an illustrative GUI 1300 for sponsors to submit sponsor content to any retail chains that participate in providing an electronic display network for customers to view and allow customers to submit user-generated content for use in creating sponsored advertisements. Allowing sponsors to selectively sponsor user-generated content advertisements in desired retail chains and particular stores within those retail chains may allow sponsors to be proactive in sponsoring user-generated content advertisements. Multiple chain and store data fields with pull-down menu selectors may be available or other selection GUI elements may be available. The GUI 1300 may be provided by a network service provider, ad agency, or other entity that assists in placing advertisements in retail store locations.

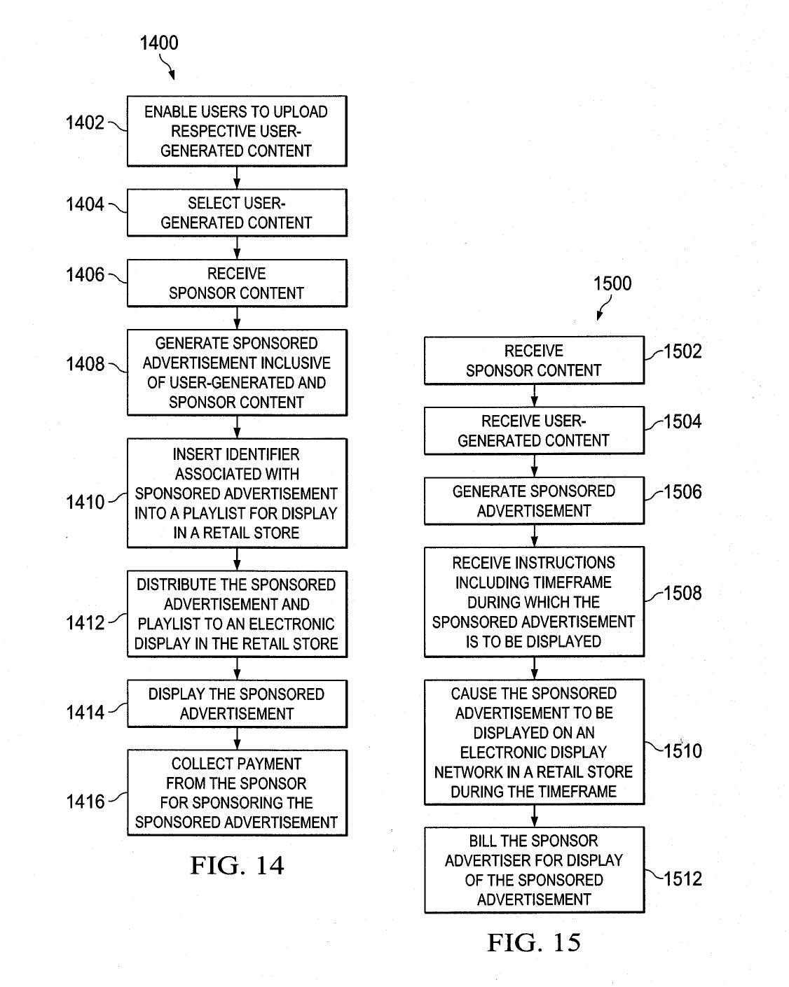

With regard to FIG. 14, a flow diagram of an illustrative process 1400 for monetizing user-generated content in a retail environment is presented. The process 1400 may enable users to upload respective user-generated content via a communications network at step 1402. At step 1404, user-generated content may be selected from one of the uploaded user-generated content submitted or uploaded by one of the users. The selection may be performed by one or more reviewers of the content. In one embodiment, the selection may be performed by multiple reviewers grading the user-generated content and then a computer may compute the average or total grade, thereby selecting a winning user-generated content (e.g., highest grade or average grade). The reviewers may be employees of a sponsor advertiser, ad agency of the sponsor advertiser, retailer, managing ad agency of the retailer, or combination thereof. Sponsor content may be received from a sponsor for displaying in association with the selected user-generated content at step 1406. At step 1408, a sponsored advertisement inclusive of the selected user-generated content and sponsor content may be generated. The generation of the sponsored advertisement may be performed by integrating the user-generated content with the sponsor content via a video or photo editing process, as understood in the art.

At step 1410, an identifier associated with the sponsored advertisement may be inserted into a playlist of content segment advertisements for display on at least one electronic display in a retail store according to the playlist. The identifier may be an alphanumeric value (e.g., name or number), that identifies the specific sponsored advertisement to be included in a playlist and displayed on an electronic display at a given or relative time. Content segment advertisements may be any advertisement that is in the form of a video or photo clip. In one embodiment, the process 1400 may include looking for an audience delivery automatically, semi-automatically, or manually prior to placing an order for the sponsored advertisement. At step 1412, the sponsored advertisement and playlist may be distributed to the electronic display(s). In an alternative embodiment, the content advertisements, including the sponsored advertisement, may be distributed to the electronic display in an ordered manner and the electronic display may display the content advertisements in that order, thereby eliminating the need for the playlist to be downloaded to the electronic display. The sponsored advertisement may be displayed on the electronic display(s) according to the playlist. At step 1416, payment from the sponsor for sponsoring the sponsored advertisement may be collected. The payment may be collected in various forms, as understood in the art. It should be understood that the payment step 1416 may occur anywhere throughout the process 1400, such as prior to inserting the sponsored advertisement at step 1410, where a booking of the sponsored advertisement may occur.

With regard to FIG. 15, an illustrative process 1500 for generating and displaying a sponsored advertisement is shown. The process 1500 starts at step 1502, where sponsor content is received. In one embodiment, the sponsor content may be received from a sponsor or its agency. Receiving the sponsor content may include an ad agency of the sponsor creating the sponsor content such that itself receives the sponsor content. The sponsor content may be an electronic data file that contains a photograph, graphics, or video. User-generated content may be received at step 1504, where the user-generated content may be a photograph or video. At step 1506, a sponsored advertisement may be generated by using an editing system to generate an advertisement that includes both the sponsor content and user-generated content. It should be appreciated that the sponsored advertisement may be any form that promotes the sponsor advertiser to viewers of the user-generated content. At step 1508, instructions including timeframe during which the sponsored advertisement is to be display may be received. The instructions may be received by a sponsor selecting a timeframe via a graphical user interface or otherwise communicating the timeframe for the sponsored advertisement to run from the sponsor advertiser to an ad agency, network operator, retailer, or any other establishment that is handling the user-generated advertisements. At step 1510, the sponsored advertisement may be caused to be displayed during the timeframe. In causing the sponsored advertisement to be displayed, the sponsored advertisement may be scheduled with a network service provider to display the sponsored advertisement to be displayed on an electronic display network in a retail stores, where the electronic display network provides for a predictable and plannable audience delivery within the retail store. In being plannable and predictable, the electronic display network is to be capable of reaching a certain percentage of the shoppers of the retail store (reach) to allow each of those shoppers to view the sponsored advertisement a predetermined number of times (frequency). At step 1512, the sponsor advertiser may be billed for display of the sponsored advertisement on the electronic display network. It should be understood that step 1512 may be performed prior to (e.g., at booking) or after actual display of the sponsored advertisement.

As previously described, the sponsored advertisement may be simultaneously displayed on a network of electronic displays throughout a retail store in an ad segment that may be established by a playlist. Alternatively, the sponsored advertisement may be displayed on a stand-alone electronic display within a retail stored. However, because the stand-alone electronic display has a smaller audience (i.e., only people who take time to view the stand-alone electronic display), the sponsorship value (i.e., amount paid for the advertisement) may be lower than that of the network of electronic displays that is configured to ensure reach to a certain shopping audience and frequency of view of the advertisements by each member of the shopping audience, as described in co-pending U.S. patent application Ser. No. 12/368,232. In one embodiment, the process 1500 may further include a selection process of submitted user-generated content for a particular category and/or retail store within a retail chain as selected by a user by entering or otherwise selecting a retail store identifier. It should be understood that multiple user-generated content may be submitted for display in different retail stores within a single retail chain and selected to be used in sponsored advertisements using the same sponsor content in the different retail stores. It should further be understood that the same sponsor content may be utilized for generating sponsored advertising using different user-generated content submitted for display at different retail stores in the same or different retail chains. In an alternative embodiment, the sponsored advertisement may be displayed on an alternative format platform, such as traditional television or the Internet. Still yet, while described as retail stores, the principles of the present invention may be incorporated into other venues, such as exercise clubs, doctors' offices, stadiums, movie theaters, and so on.

The previous detailed description of a small number of embodiments for implementing the invention is not intended to be limiting in scope. One of skill in this art will immediately envisage the methods and variations used to implement this invention in other areas than those described in detail. The following claims set forth a number of the embodiments of the invention disclosed with greater particularity.

What is claimed:

1. A method for monetizing user-generated content in a retail environment, said method comprising:
enabling users to upload respective user-generated content via a communications network;
selecting user-generated content submitted by one of the users from among a plurality of uploaded user-generated content submitted by multiple users;
receiving sponsor content from a sponsor for displaying in association with the selected user-generated content;
generating a sponsored advertisement inclusive of the selected user-generated content and sponsor content;
inserting an identifier associated with the sponsored advertisement into a playlist of content segment advertisements for display on at least one electronic display in a retail store according to the playlist;
distributing the sponsored advertisement and playlist to the at least one electronic display;
displaying the sponsored advertisement on the at least one electronic display according to the playlist; and
collecting payment from the sponsor for sponsoring the sponsored advertisement.

2. The method according to claim 1, further comprising receiving customer identifiers associated with respective users that upload the user-generated content.

3. The method according to claim 2, further comprising selecting a retail store that is associated with a customer identifier associated with the user that uploaded the selected user-generated content in which to display the sponsored advertisement.

4. The method according to claim 1, further comprising receiving a store identifier from each of the users that upload the user-generated content to identify which retail stores from among a plurality of retail stores in a retail chain are each of the respective users' primary retail store, the primary retail stores being the retail stores in the retail store chain at which each respective user primarily shops.

5. The method according to claim 4, wherein selecting from among a plurality of uploaded user-generated content includes selecting from among a plurality of uploaded user-generated content associated with a single retail store.

6. The method according to claim 1, wherein generating the sponsored advertisement includes including an indicia associated with the retail store.

7. The method according to claim 1, further comprising displaying the sponsored advertisement substantially simultaneously on a plurality of electronic displays operating in an electronic display network throughout the retail store.

8. The method according to claim 1, further comprising enabling the users to select a category from among multiple categories for which the user-generated content is to be considered for selection.

9. The method according to claim 8, further comprising organizing each of the user-generated content by category for selection of the user-generated content.

10. The method according to claim 1, further comprising assigning dates of play that the user-generated content is scheduled to play.

11. The method according to claim 10, further comprising notifying the respective user of the selected user-generated content of the selection and assigned dates of play.

12. A method for monetizing an advertisement in a retail environment, said method comprising:
receiving, from a user, user-generated content in the form of an electronic image;
generating a sponsored advertisement by including sponsor content of a sponsor advertiser and the user-generated content in an advertisement;
establishing a timeframe during which the sponsored advertisement is to be displayed;
causing the sponsored advertisement to be displayed during the timeframe on an electronic display network in a retail store, the electronic display network providing for a predictable and plannable audience delivery within the retail store; and
billing the sponsor advertiser for display of the sponsored advertisement on the electronic display network.

13. The method according to claim 12, further comprising selecting the user-generated content from among multiple user-generated content submitted by multiple users submitted for selection to be included in the sponsored advertisement.

14. The method according to claim 13, further comprising enabling a user to select a category in which the user-generated content is to be submitted for consideration for inclusion in a sponsored advertisement.

15. The method according to claim 12, further comprising:
receiving, from a second user, second user-generated content in the form of an electronic image;
generating a second sponsored advertisement by including the sponsor content and second user-generated content in a second advertisement;
establishing (i) a second timeframe during which the second sponsored advertisement is to be displayed and (ii) a different retail store in which the second sponsored advertisement is to be displayed; and
causing the second sponsored advertisement to be displayed during the timeframe at the different retail store.

16. The method according to claim 12, further comprising receiving instructions from the sponsor advertiser or its agency including the timeframe during which the sponsored advertisement is to be displayed.

17. The method according to claim 12, further comprising communicating the sponsored advertisement to a plurality of retail stores within different respective retail chains.

18. The method according to claim 12, further comprising communicating the sponsored advertisement to a plurality of retail stores within a single retail chain.

19. The method according to claim 12, further comprising selecting sponsor content that is relevant to the user-generated content.

20. A method for monetizing user-generated content, said method comprising:
providing sponsor content that identifies an advertiser;
combining the sponsor content with user-generated content to create a sponsored advertisement; and
causing the sponsored advertisement to be displayed on an electronic display network in a retail store that provides for plannable and predictable audience delivery of customers of the retail store.

21. The method according to claim 20, further comprising editing the user-generated content for inclusion in the sponsored advertisement.

22. The method according to claim 20, wherein causing the sponsored advertisement to be displayed on an electronic display network includes booking the sponsored advertisement for display within at least one retail store of multiple, different retail chains.

23. The method according to claim 22, further comprising causing the sponsored advertisement to be displayed within the at least one retail store of multiple different retail chains within at least one designated market area (DMA).

24. The method according to claim 20, further comprising receiving the user-generated content from a user for inclusion in a sponsored advertisement in a particular category with which the content is related.

25. The method according to claim 20, further comprising selecting the user-generated content from among multiple user-generated content submitted by multiple different users for selection to be included in a sponsored advertisement.

26. The method according to claim 20, wherein causing the sponsored advertisement to be displayed includes causing the sponsored advertisement to be displayed during select dates, and further comprising notifying a user that submitted the user-generated content of the select dates during which the sponsored advertisement with the user-generated content is to be displayed on the electronic display network.
